(19) United States
(12) Patent Application Publication
(10) Pub. No.: US 2009/0138579 A1
(43) Pub. Date: May 28, 2009

(54) REMOTE CONFIGURATION OF ELECTRONIC DEVICE WITH USER INTERFACE PROVIDED FROM ELECTRONIC DEVICE

(75) Inventor: Nae Kwon JUNG, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: Emtrace Technologies, Inc., Seoul (KR)

(21) Appl. No.: 11/945,092

(22) Filed: Nov. 26, 2007

(51) Int. Cl. G06F 15/177

(52) U.S. Cl. 709/221

(57) ABSTRACT

An electronic device is remotely configured from a remote server using user interface information stored in the electronic device. The method comprises a server receiving user interface information stored in the electronic device via a data communication network from the electronic device, where the server is communicatively coupled to the electronic device through a data communication network. The server causes a user interface to be generated and displayed on a user computer based on the received the user interface information, where the user computer is communicatively coupled to the server through the data communication network. The server receives configuration information for configuring an application to be executed on the electronic device from the user computer, and transmits the received configuration information to the electronic device via the data communication network to remotely configure the application to be executed on the electronic device.

### BACKGROUND OF THE INVENTION

1. Field of the Invention

The present invention relates to configuring an electronic device and, more specifically, to configuring an electronic device from a remote web site with a user interface provided from the electronic device itself.

2. Description of the Related Art

With the development of hardware and networking technology, an increasing number of electronic devices are being connected to communication networks, such as the Internet. For example, computing devices such as personal digital assistants, smartphones, and printers as well as home-networked electronic devices such as televisions, refrigerators, electronic picture frames, and desktop widget devices are being connected to the Internet.

These electronic devices can be controlled remotely from a remote computer through the connected network. Conventional methods of remotely controlling the electronic devices through the network typically employ a small web server embedded in the electronic device itself and have the remote computer connect to the small web server on the electronic device using a web browser for the remote computer to communicate with the electronic device and control the electronic device. For example, a network router can be remotely controlled through such conventional method.

However, in order for the remote computer to connect to the electronic device through the network, the remote computer needs information on the IP (Internet Protocol) address of the device, which makes it inconvenient and cumbersome to control the electronic device remotely. Moreover, the remote computer needs a direct outbound HTTP (Hypertext Transfer Protocol) port open toward the electronic device to be controlled in order for the web browser on the remote computer to connect to the small web server on the electronic device. This is possible only in limited circumstances, for example, where the remote computer and the electronic device are part of the same local network.

Another method of remotely controlling the electronic devices is to use the server computer as a gateway or a proxy between the electronic devices and the remote computer. The control information entered is stored in the server and downloaded to or synchronized with the electronic device remotely through the network. The remote computer connects to the server to modify the control information. However, such method may not be feasible for use with many different types of electronic devices, because each of the electronic devices may have different parameters to be controlled, with the different types of electronic devices and different firmware versions even with the same type of electronic device. For example, the remote computer may be used to remotely control the parameters of a home networked refrigerator and a desktop widget device, which may require different user interfaces for control. For another example, the remote computer may also be used to remotely control the parameters of two same desktop widget devices with different firmware versions, which may also require different user interfaces for control.

It is also not feasible for the remote computer to preload or hard-code the user interface for all different types of electronic devices that may be connected to the remote computer for remote configuration. For example, if the electronic device is upgraded with a new software component or a new version of firmware, it may not be possible for the remote computer to preload or hard-code the appropriate user interface compatible with the new software component or new version of firmware.

Thus, there is a need for a more convenient and more effective technique for remotely configuring and controlling an electronic device through a remote computer connected to the electronic device over a network. There is also a need for a remote configuration technique that can accommodate the different types of user interfaces that the electronic devices may require for control and configuration, without having to preload or hard-code such user interfaces on the remote computer.

### SUMMARY OF THE INVENTION

Embodiments of the present invention include a computer-implemented method of remotely configuring an electronic device from a remote server using user interface information stored in the electronic device. In one embodiment, the method comprises a server receiving user interface information stored in the electronic device via a data communication network from the electronic device, where the server is communicatively coupled to the electronic device through a data communication network; the server causing a user interface for configuring an application to be executed on the electronic device to be generated and displayed on a user computer based on the received user interface information, where the user computer is communicatively coupled to the server through the data communication network; the server receiving configuration information for configuring the application from the user computer; and the server transmitting the received configuration information to the electronic device via the data communication network to remotely configure the application to be executed on the electronic device.

The present invention can be implemented as a computer program product stored on a computer readable storage medium adapted to perform the computer-implemented of remotely configuring an electronic device from a remote server using user interface information stored in the electronic device. Such computer program product may also be stored in a computer apparatus.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates a system architecture for remote configuration of electronic devices through a service provider server connected via a network, according to one embodiment of the present invention.

FIG. 2A illustrates the hardware system of an electronic device such as a desktop widget player, according to one embodiment of the present invention.

FIG. 2B illustrates the software modules of the electronic device such as a desktop widget player, according to one embodiment of the present invention.

FIG. 3A illustrates the hardware system of a service provider server used for remote configuration of the electronic device, according to one embodiment of the present invention.

FIG. 3B illustrates the software modules of the service provider server used for remote configuration of the electronic device, according to one embodiment of the present invention.

FIG. 4 is an interaction diagram illustrating a method for registering the electronic device with the service provider server used for remote configuration of the electronic device, according to one embodiment of the present invention.

FIG. 5A is an interaction diagram illustrating a method for configuring the electronic device remotely from the service provider server, according to one embodiment of the present invention.

FIG. 5B and FIG. 5C illustrate the different user interface code stored in the electronic devices and the different user interfaces corresponding to the different user interface code to be displayed by the service provider server, according to one embodiment of the present invention.

FIG. 5D is an interaction diagram illustrating a method for configuring a group of the electronic devices remotely from the service provider server, according to another embodiment of the present invention.

FIG. 6 is an interaction diagram illustrating a method for configuring the electronic device locally, according to one embodiment of the present invention.

FIG. 7 is a flowchart illustrating a method for synchronizing the configuration information between the service provider server and the electronic device, according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

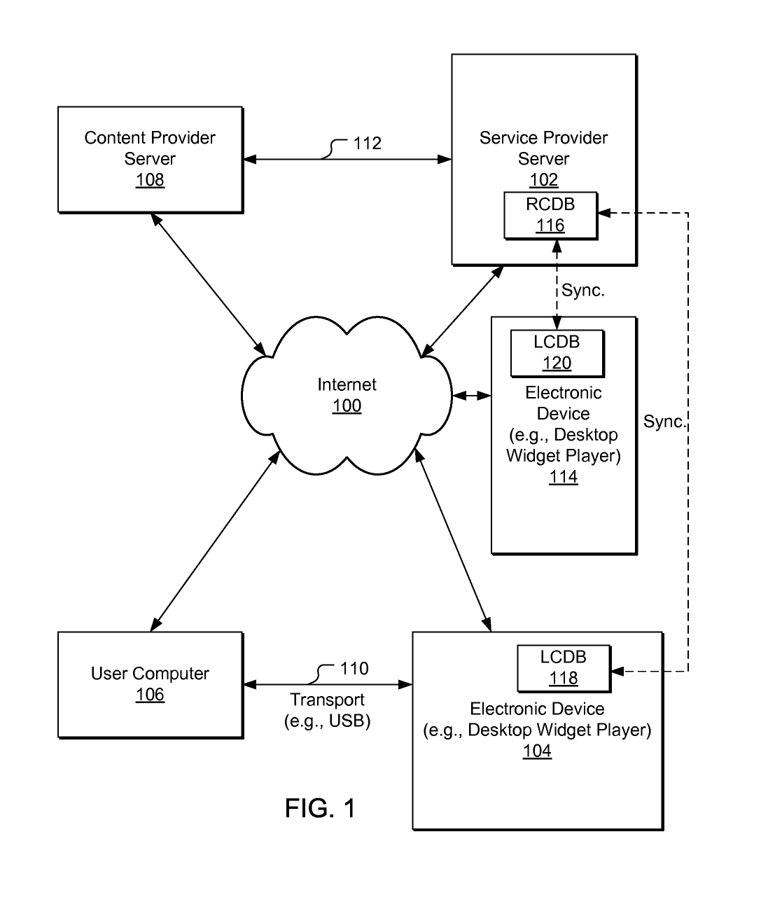

FIG. 1 illustrates a system architecture for remote configuration of electronic devices through a service provider server connected via a network, according to one embodiment of the present invention. The system includes at least a service provider server 102, an electronic device 104, and a user computer 106, communicatively coupled to each other through a data communication network such as the Internet 100. Optionally, the system may additionally include additional electronic devices 114 and a content provider server 108 used to push content to the electronic device 104 if the electronic device 104 is a desktop widget player.

Conventionally, software “widgets” are small application programs that run on personal computers used to quickly receive a variety of information in which the user is interested in. Software “widgets” running on the user computer may pull information from a content provider server for review by the user. For example, a variety of information, such as weather information, stock prices, news, and the like, may be pulled from the content provider server to the software “widgets” running on the personal computer. Some or all of such information may be provided by another content provider server to the service provider server and the software “widgets” may pull such information also from the service provider server.

In contrast, in this example of FIG. 1, the electronic devices 104, 114 are desktop widget players of a stand-alone type, such as the “WidgetStation” desktop widget player created by Emtrace Technologies, Inc. of Seoul, South Korea. The desktop widget players 104, 114 are separate hardware devices and are not software applications running on the user computer 106. In fact, the desktop widget players 104, 114 may be physically remote from the user computer 106. In one embodiment, client software runs on the desktop widget players 104, 114 to pull information and content from the content provider server 108. In another embodiment, a small RSS (e.g., Really Simple Syndication for RSS 2.0) client software runs on the desktop widget players 104, 114 to receive the information pushed by the content provider server 108 or the service provider server 102 to the desktop widget players 104, 114. For example, a variety of information, such as weather information, stock prices, news, and the like, may be pulled from the content provider server 108 or the service provider server 102 to the desktop widget players 104, 114. As will be explained in more detail below, each of the electronic devices 104, 114 also includes a LCDB (Local Configuration Database) 118, 120 that stores configuration information.

In one embodiment, the desktop widget players 104, 114 pull such information of interest from the content provider server 108 through the Internet 100. In one embodiment, the content provider server 108 and the service provider server 102 communicate with the desktop widget players 104, 114 through the Internet 100 using an XML (Extensible Markup Language) protocol. In another embodiment, the content provider server 108 pushes RSS feeds to the desktop widget players 104, 114 using the XML protocol agreed upon between the content provider server 108 and the desktop widget players 104, 114. In addition, the desktop widget players 104, 114 may also pull content from, or receive RSS feeds pushed from, the service provider server 102 in other embodiments. As will be explained in more detail below, the service provider server 102 also includes an RCDB (Remote Configuration Database) that stores configuration information for some or all of the electronic devices (e.g., desktop widget players) 104, 114 connected to the service provider server 102.

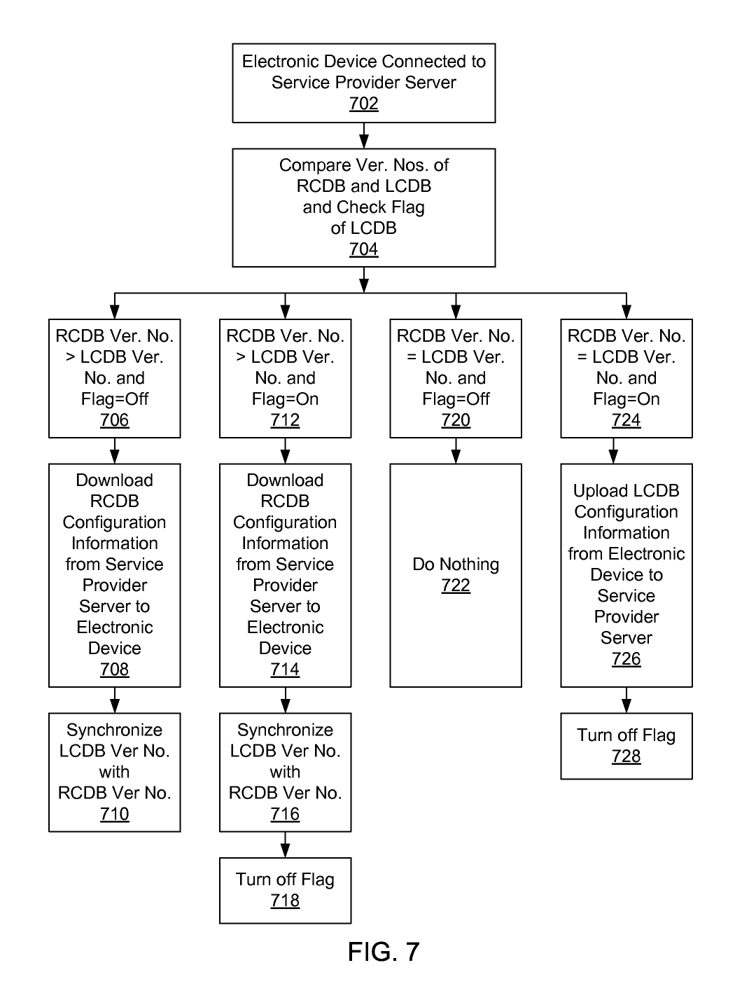

As will be explained in more detail below, the system of FIG. 1 enables configuring a variety of parameters of the electronic devices 104, 114, such as a variety of software parameters of an application running on the desktop widget players 104, 114, remotely through the service provider server 102, using user interfaces (not shown in FIG. 1) stored on the electronic devices 104, 114 themselves. As will be explained below, the user interfaces are customized for each of the different electronic devices 104, 114. The electronic devices 104, 114 send the stored user interfaces to the service provider server 102 via the Internet 100 for display on a remote user computer. Such user interface is accessed by a user from the remote user computer 106 through the Internet 100. The user may configure the variety of parameters of the electronic devices 104, 114 by entering the configuration information using the user interface displayed on the user computer 106 by the service provider server 102, which user interface was provided by the electronic devices 104, 114 to the service provider server 102. The entered configuration information is stored in the RCDB 116 and transmitted back by the service provider server 102 to the electronic devices 104, 114 so that the configuration information stored in the LCDBs 118, 120 of the electronic devices 104, 114 becomes synchronized with the configuration information stored in the RCDB 116 of the service provider server 102. A more detailed explanation of such synchronization process is provided below with reference to FIG. 7. In this manner, the electronic devices 104, 114 and the software running on the electronic devices 104, 114 can be configured remotely through the service provider server 102, using a user interface that was customized for each electronic device 104, 114 and provided by the electronic devices 104, 114 themselves to the service provider server 102.

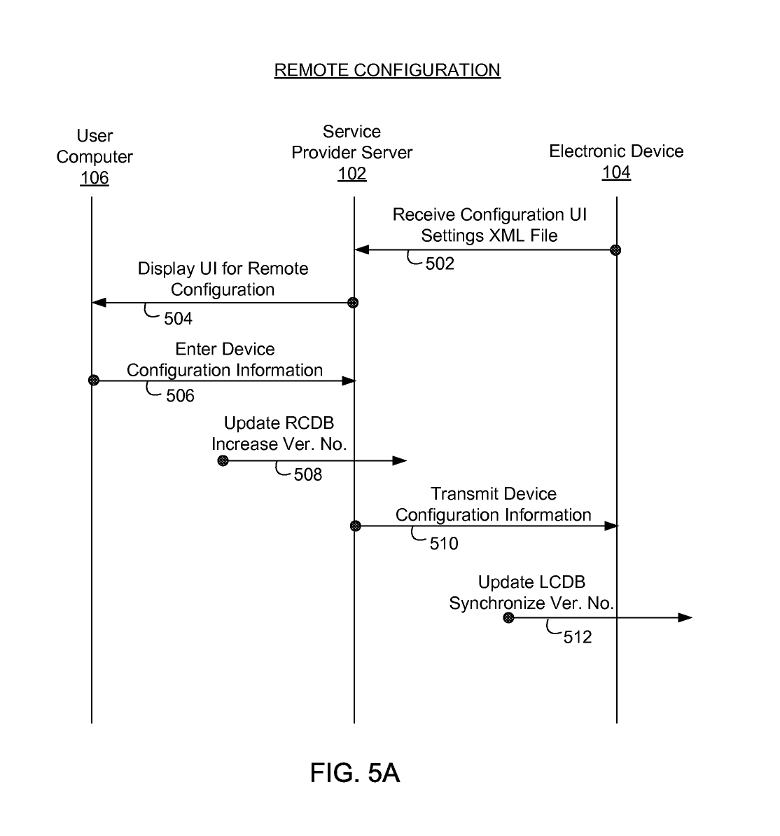

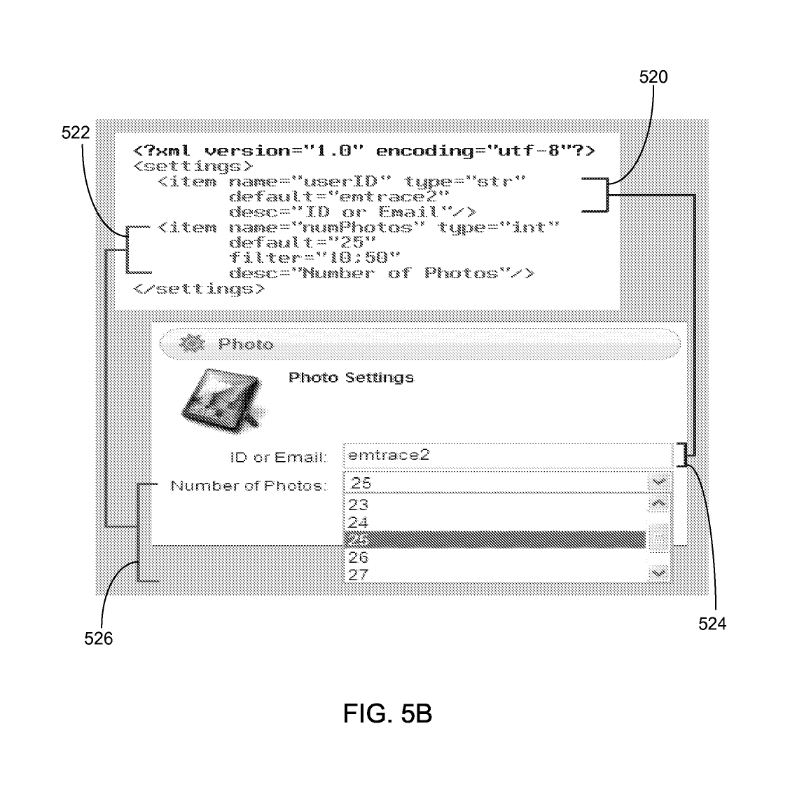

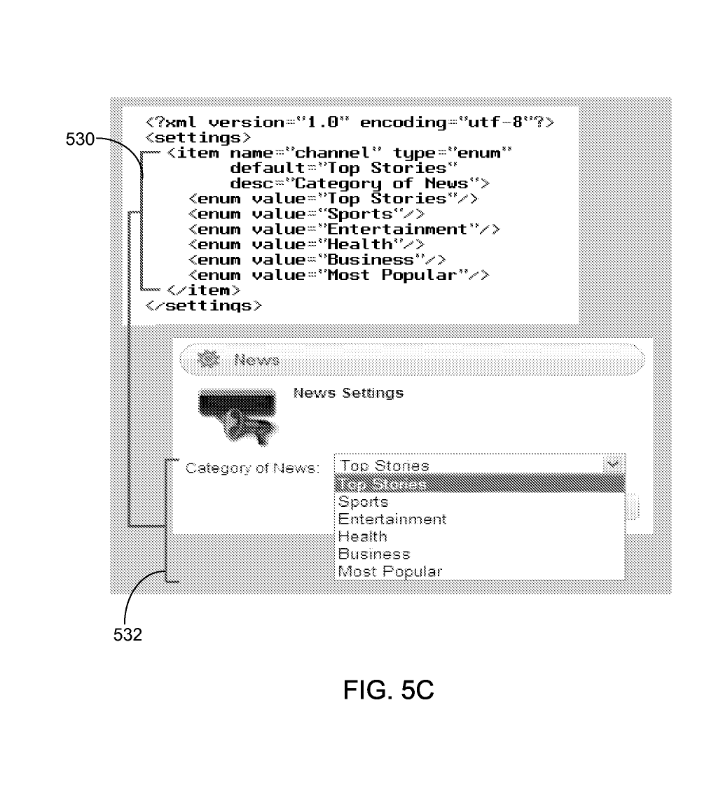

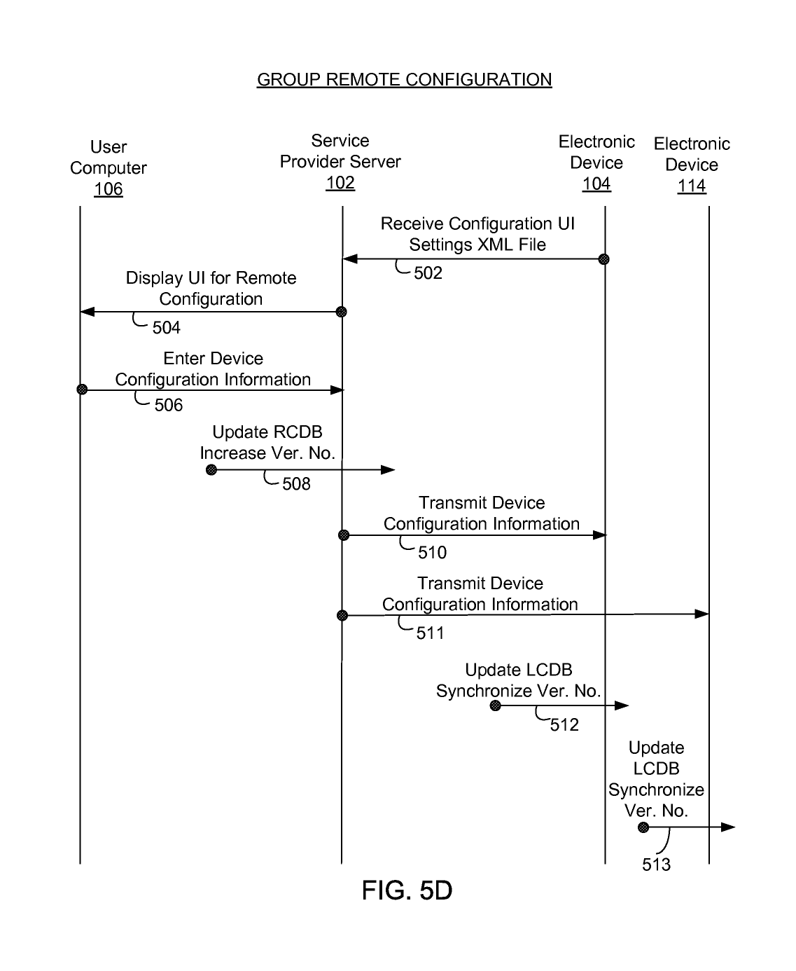

Although FIG. 1 shows both electronic devices 104, 114 as desktop widget players, the electronic devices 104, 114 may be different types of electronic devices, such as a television, refrigerator, electronic picture frames, a network router, etc. Also, the electronic device 104 may be different from the electronic device 114. For example, the electronic device 104 may be a desktop widget player running a weather RSS client, and the electronic device 114 may be a network-connected electronic picture frame. Also, although FIG. 1 shows only two electronic devices 104, 114 for configuration, the system of FIG. 1 may be used with any number of electronic devices. Some of the electronic devices may be grouped together to be configured in the same way as a group, as will be explained in more detail with reference to FIG. 5D. It should be noted that any different combination of different or same types of electronic devices may be feasible with the system of FIG. 1, so long as they need to be configured and have basic computing capability and network connectivity, and that the present invention is not limited to a particular type or particular number of electronic devices to be configured.

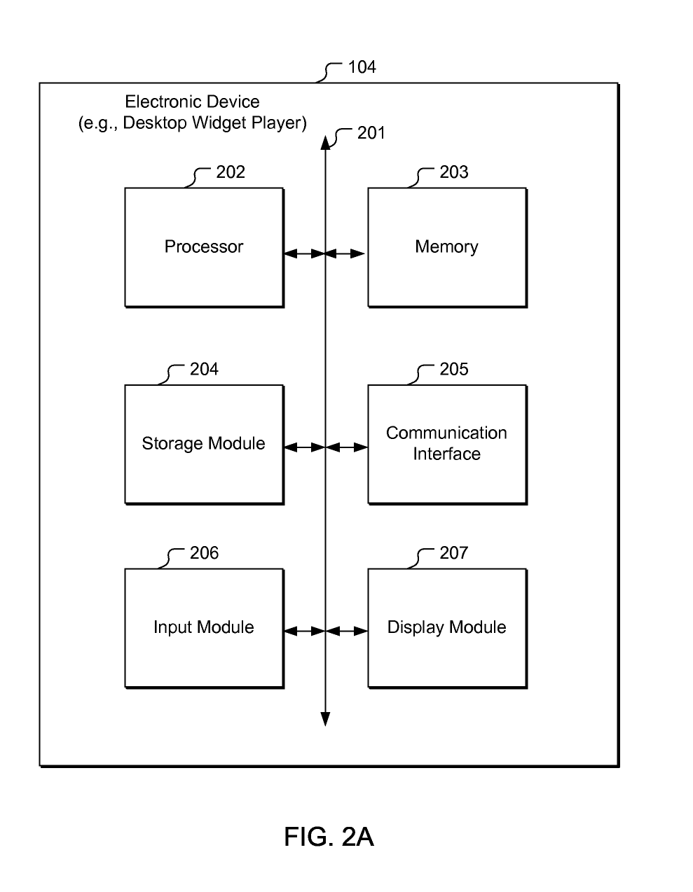

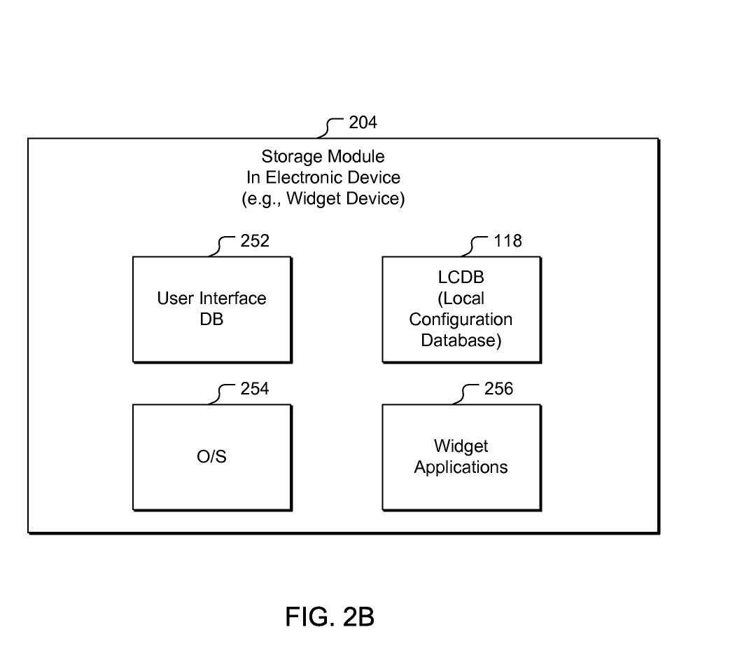

FIG. 2A illustrates the hardware system of an electronic device such as a desktop widget player, according to one embodiment of the present invention. The example of FIG. 2A illustrates the hardware architecture of desktop widget player 104 as the electronic device, although other types of electronic devices may be used. In addition, the desktop widget player 104 may be part of a larger appliance, such as a refrigerator, an air conditioning unit, a television, or other types of home appliances. Also note that the electronic device 114 may have the same or similar hardware architecture as shown in FIG. 2A for the electronic device 104.

Referring to FIG. 2A, the electronic device 104 has at least the functionalities of a basic computing device, and includes a processor 202, a memory 203, a storage module 204, a communication interface 206, an input module 206, and a display module 207. Note that not all components of the electronic device 104 are shown in FIG. 2A and that certain components not necessary for illustration of the present invention (for example, audio speakers) are omitted herein. Each of the components of the electronic devices 104, 114 may be communicatively coupled through a bus 201.

The processor 202 is a conventional processor or controller such as an ARM9 type processor or an Intel® XScale® processor. The memory 203 is conventional computing memory such as a random access memory (RAM). The storage module 204 is a conventional long term storage device, for example, a flash memory or a hard disk drive (e.g., magnetic hard drive). The storage module 204 typically stores conventional operating systems such as a Linux-based operating system, Garnet™ OS or Palm OS® from Access Co., Ltd., or Windows CE or Windows Mobile from Microsoft® Corporation and other software applications for use by the electronic device 104 as will be explained in more detail below with reference to FIG. 2B. The input module 206 can be a keyboard, a touch sensitive screen, or any other type of input device, and the display module 207 can be a liquid crystal display (LCD) device or any other type of display device. In one example, the display module 207 may be a dual screen LCD module.

The communication interface 205 may include one or more wired or wireless communication interfaces used to communicate with the service provider server 102 over the Internet 100 and also one or more local communication interfaces. For example, the communication interface 205 may include an Ethernet (e.g., 10Base-T0 interface and/or a Wi-Fi interface (e.g., IEEE 802.11b/g)) for communication via the Internet, and a USB (Universal Serial Bus) interface, a serial interface, a parallel interface, and/or a Bluetooth interface for communication with another computer (not shown) locally.

FIG. 2B illustrates the software modules of the electronic device such as a desktop widget player, according to one embodiment of the present invention. The storage module 204 in the electronic devices 104, 114 includes at least a user interface database (DB) 252, a LCDB (local configuration database) 116, the operating system (O/S) 254, and a variety of widget applications 256 or other application software 256.

The user interface DB 252 stores one or more sets of code for displaying user interfaces to be used for configuring a variety of parameters of the electronic device 104, 114 itself or the configuring parameters of the applications running on the electronic devices 104, 114. More specifically, the user interface DB 252 stores one or more XML files that describe the user interface to be used for configuring the electronic device 104, 114 itself or of the applications running on the electronic devices 104, 114. Such XML files are transmitted remotely to the service provider server 102 via the Internet 100, so that the corresponding user interface is displayed by the service provider server 102 on a display of the user computer 106 via the Internet 100. Examples of the code stored in the user interface DB 252 are illustrated in more detail below with reference to FIGS. 5B and 5C. Since the electronic devices 104, 114 themselves store the XML files corresponding to the user interfaces, the service provider server 102 does not have to store information on the user interfaces for the electronic devices. If the electronic device 104 stores an XML file for configuration of the electronic device 104 that is different from another XML file stored in the electronic device 114 for configuration of the electronic device 114, the service provider server 102 is able to display two different user interfaces each corresponding to the electronic device 104 and the electronic device 114 on the user computer 106 via the Internet.

The LCDB 118 stores the configuration data corresponding to the electronic device 104 itself or of the applications running on the electronic devices 104. Such configuration data is what was entered by a user from the user computer 106 onto a user interface displayed on the user computer 106 by the service provider server 102, which user interface was stored in and provided by the electronic device 104 itself. The LCDB 118 synchronizes with the configuration data stored in the RCDB 116 of the service provider server, as will be explained below in more detail with reference to FIG. 7. In one embodiment, the configuration data stored in the LCDB may have the form of a pair of (i) a key and (ii) a value corresponding to the key, for convenient programmatic access to the configuration data. For example, the configuration data may include data for display parameters, audio parameters, and alarm parameters for a clock widget application running on the electronic device 104, such as: “volume”=“30”; “brightness”=“10”; “alarm”=“07:00 AM.” In addition, the configuration data may have keys that are hierarchical with related parameters grouped together. For example, the configuration data may include data for configuring an electronic photo album widget application running on the electronic device 104, such as “sound/volume”=“30”; “sound/balance”=“1.0”; “photo/slideshowEffect”=“random”; “photo/numPhotos”=“20.”

The widget applications 256 may include, for example, client software for pulling various information from the content provider server 108 or RSS client software for receiving various RSS feeds from the content provider server 108. Other software applications 256 may also be stored in the storage module 204 to run on the electronic device 104. The O/S module 254 stores the operating system that runs on the electronic device 104.

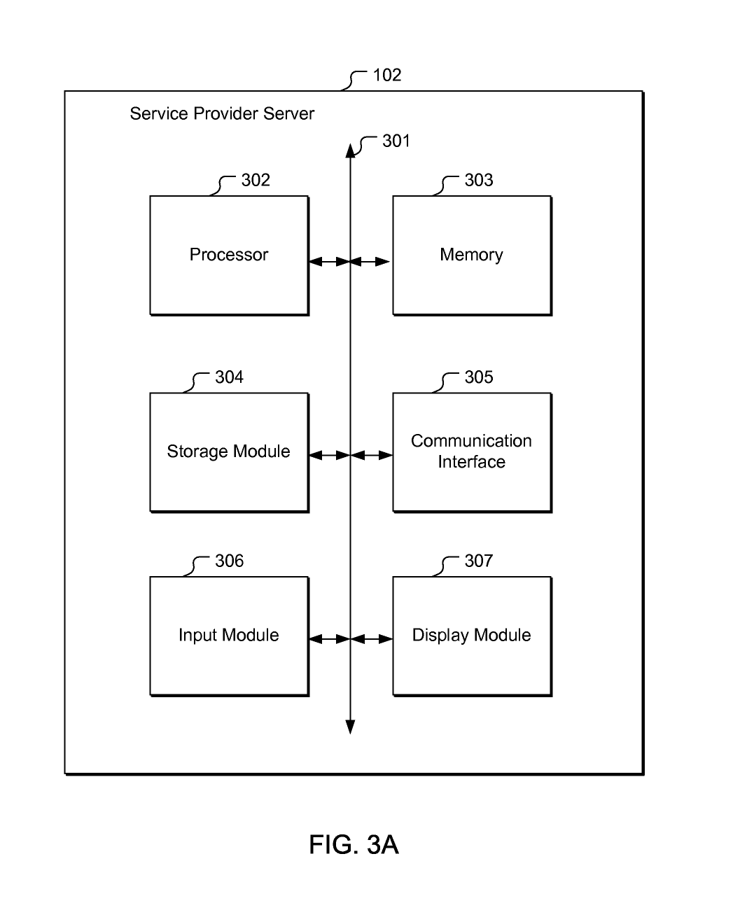

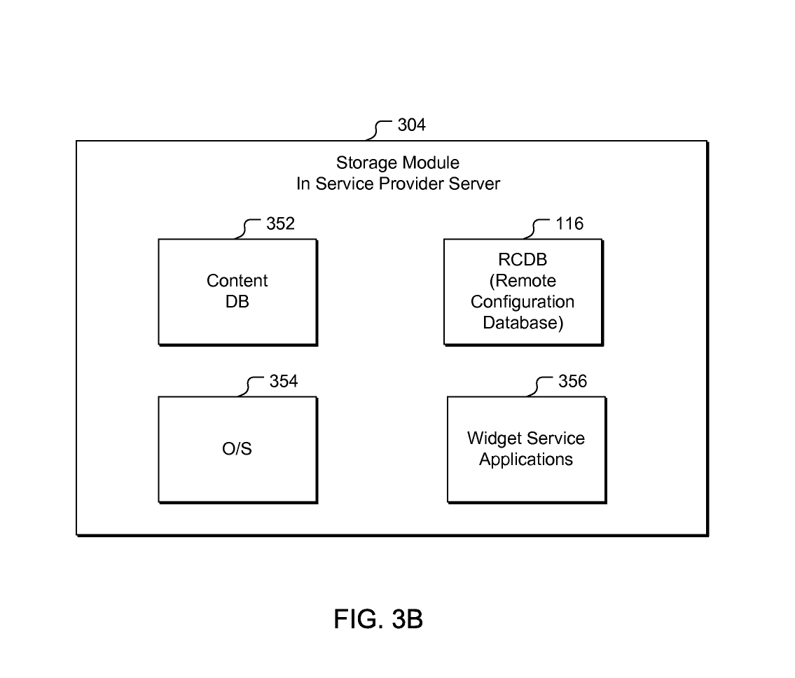

FIG. 3A illustrates the hardware system of a service provider server used for remote configuration of the electronic device, according to one embodiment of the present invention. In one embodiment, the service provider server 102 is a conventional server computer including a processor 302, a memory 303, a storage module (e.g., hard disk drive) 304, an input module (e.g., keyboard, mouse, and the like) 306, a display module 307, and a communication interface 305, exchanging data with one another through a bus 301. The communication interface 305 may include one or more wired or wireless communication interfaces used to communicate with the electronic devices 104, 114 over the Internet 100. For example, the communication interface 205 may include an Ethernet (e.g., 10Base-T0 interface and/or a Wi-Fi interface (e.g., IEEE 802.11b/g)) for communication via the Internet 100. The storage module 304 stores software that is run by the processor 302 in conjunction with the memory 303 to manage the exchange of data between the service provider server 102 and the electronic devices 104, 114 over the Internet 100. Operating system software and other application software may also be stored in the storage device 304 to run on the processor 302, as shown in FIG. 3B. Note that not all components of the service provider server 102 are shown in FIG. 3A and that certain components not necessary for illustration of the present invention are omitted herein.

FIG. 3B illustrates the software modules of the service provider server used for remote configuration of the electronic device, according to one embodiment of the present invention. The storage module 304 in the service provider server 102 includes at least a content DB 352, a RCDB (remote configuration database) 116, an O/S module 354, and a variety of widget service applications 356 or other application software 356.

The content DB 352 stores a variety of content that may be pulled by the electronic devices 104, 114 or may be pushed to the electronic devices 104, 114 as RSS feeds. For example, when the electronic devices 104, 114 are desktop widget players running RSS clients for weather information, stock information, news information, etc., the content DB 352 stores such corresponding content (weather, stock quotes, news, etc.). Some or all of the content stored in the content DB 352 may be provided to the service provider server 102 by the content provider server 108.

The RCDB 116 stores the configuration data (also referred to herein as configuration information) corresponding to the electronic device 104 itself or of the applications running on the electronic devices 104. Such configuration data is what was entered by a user from the user computer 106 onto a user interface displayed on the user computer 106 by the service provider server 102. Such user interface was stored in and provided by the electronic device 104 itself as explained above. The RCDB 116 synchronizes with the configuration data stored in the LCDB 118, 120 of the electronic devices 104, 114, as will be explained below in more detail with reference to FIG. 7. The format of the configuration data in the RCDB 116 would be in the same format as the configuration data stored in the LCDB 118 of the electronic device 104. If the service provider server 102 is configured to operate together with multiple electronic devices 104, 114, then the RCDB 116 is partitioned so that a part of the RCDB 116 is synchronized with the LCDB 118 of the electronic device 104 and another part of the RCDB 116 is synchronized with the LCDB 120 of the electronic device 114.

The widget service applications 356 may include, for example, the RSS server software for pushing various RSS feeds from the service provider server 102 to the electronic devices 104, 114. Other software applications 356 may also be stored in the storage module 304 to run on the service provider server 102. For example, the software applications 356 may include configuration software adapted to cause a user interface to be displayed on the user computer 106 and to receive configuration data for the electronic devices 104, 114 from the user computer 106 using such displayed user interface. Such user interface was stored in and provided by the electronic devices 104, 114 themselves as explained above. Such configuration software may include “wrapper” software that is executed together with the XML files that include the user interface data, for access to the system API (Application Program Interface) of the service provider server 102. The O/S module 354 stores the operating system that runs on the service provider server 102.

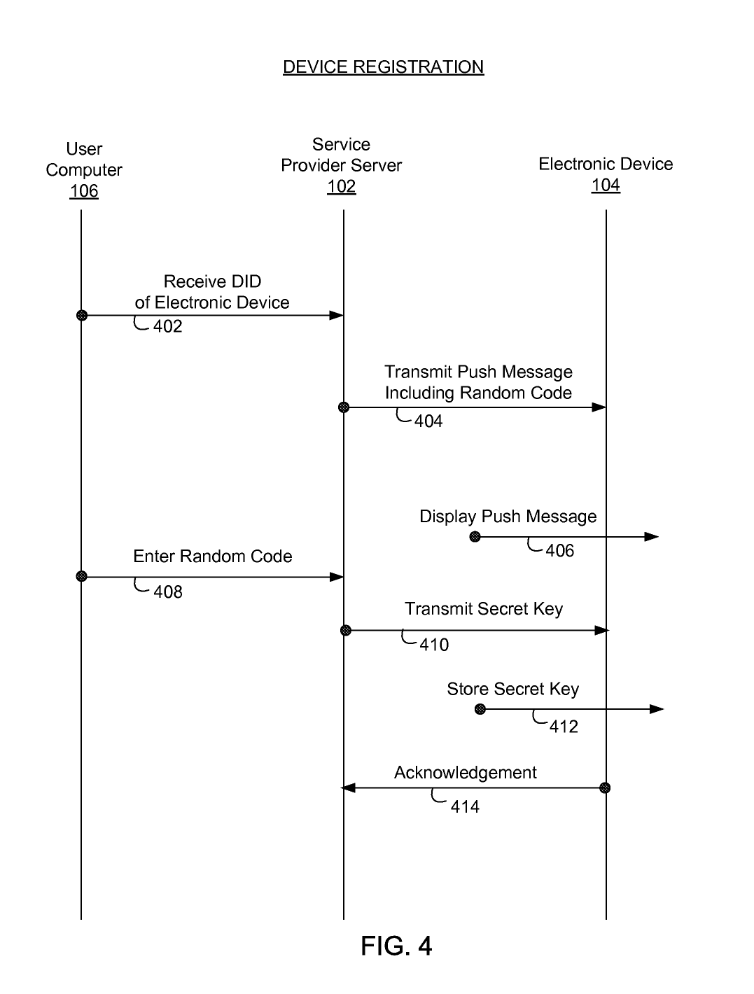

FIG. 4 is an interaction diagram illustrating a method for registering the electronic device with the service provider server used for remote configuration of the electronic device, according to one embodiment of the present invention. The electronic devices 104, 114 first need to be registered with the service provider server 102, so that the service provider server 102 may recognize the electronic devices 104, 114 for communication and remote configuration. In one embodiment, each electronic device 104, 114 has a unique device identification (DID). As will be explained in more detail below, multiple electronic devices 104, 114 may be configured together as a group if the multiple electronic devices are designated as one group, for example, on the service provider server 102.

The user can recognize the DID of the electronic device (e.g., 104) when the user is located locally to the electronic device. For example, the DID may be physically placed on the electronic device 104. The user can enter the DID to the service provider server 102 using the user computer 106, while the electronic device 104 is connected to the service provider server 102 through the Internet 100. Thus, referring to FIG. 4, the service provider server 102 receives 402 the DID of the connected electronic device from the user computer 106. In response, the service provider server 102 pushes 404 a message including a random code to the electronic device 104. This random code is a randomly generated code that will be used for authentication of the user's use of the electronic device 104. The electronic device 104 displays 406 such pushed message including the random code. The user will then recognize the random code and enters 408 the displayed random code to the service provider server 102 from the user computer 106. This means that the user is actually using the electronic device 104 locally with the user computer 106. If the random code entered from the user computer 106 matches the random code transmitted 404 to the electronic device 104 by the service provider server 102, then the service provider server 102 transmits 410 a secret key to the electronic device 104, which is stored 412 in the electronic device 104. The secret key is what is used for authentication of the electronic device 104 and secure communication between the electronic device 104 and the service provider server 102. The secret key may also be a randomly generated number. Then, the electronic device 104 transmits an acknowledgement 414 to the service provider server 102, acknowledging that the electronic device 104 has received the secret key and is ready to communicate with the service provider server 102. As a result, the registration process is complete and further communication between the service provider server 102 and the electronic device 104 is carried out using the secret key without any further registration or authentication process.

FIG. 5A is an interaction diagram illustrating a method for configuring the electronic device remotely from the service provider server, according to one embodiment of the present invention. The method of FIG. 5A enables the service provider server 102 to receive customized user interfaces for configuring the electronic devices 104, 114 from the electronic devices 104, 114 themselves, so that the service provider server 102 does not have to store any of the user interface information. Changes to the user interfaces can also be made very conveniently, because each individual electronic device 104, 114 just has to modified to store different user interface settings.

Referring to FIG. 5A, first the service provider server receives 502 the configuration UI (user interface) settings XML file from the electronic device 104. As explained previously, the configuration UI settings XML file is stored in the electronic device 104 itself. The service provider server 102 generates the user interface as an HTML (hypertext markup language) file using the configuration UI settings XML file and causes the UI to be displayed 504 on the user computer 106 through the Internet 100. The user enters 506 device configuration information (including configuration information for applications running on the electronic device 104) to the user computer 106 and the entered configuration information is transmitted 506 to the service provider server 102. The service provider server 102 updates 508 its RCDB 116 with the entered configuration information, and increases a version number associated with the RCDB 116. The version number is used to indicate the number of updates made to the RCDB 116 and which version the configuration information corresponds to, and is also used to determine whether or not there is a difference between the configuration data stored in the RCDB 116 and the configuration stored in the LCDB 118, 120 and they need to be synchronized. In one example, the version number of the RCDB 116 may correspond to the version number for all the configuration information, or in other examples may be associated with a particular type of the configuration information (e.g., separate version numbers for different types of configuration information). Then, the service provider server 102 transmits 510 the device configuration information to the electronic device 104. The electronic device 104 updates its LCDB 118 with the received configuration information, and also synchronizes the version number associated with the configuration information stored in the LCDB 118 to be same as the version number associated with the configuration information stored in the RCDB 116. Again, in one example, the version number of the LCDB 118 may correspond to the version for all the configuration information, or in other examples may be associated with a particular type of the configuration information (e.g., separate version numbers for different types of configuration information) stored in the LCDB 118. As a result, the electronic device 104 becomes remotely configured through the service provider server 102, using the user interface settings stored in and provided by the electronic device 104 itself.

FIG. 5B and FIG. 5C illustrate the different user interface code stored in the electronic devices and the different user interfaces corresponding to the different user interface code to be displayed on the service provider server, according to one embodiment of the present invention. For example, FIG. 5B may correspond to the UI settings stored in the electronic device 104 and the UI displayed through the service provider server 102 on the user computer 106 for configuring the electronic device 104, and FIG. 5B may correspond to the UI settings stored in the electronic device 114 and the UI displayed through the service provider server 102 on the user computer 106 for configuring the electronic device 114. As is shown in FIG. 5B and FIG. 5C, the different configuration settings stored separately in the electronic devices 104, 114 result in different user interfaces displayed on the user computer 106.

Referring to FIG. 5B, the XML code 520 is for displaying the part 524 of the user interface shown in FIG. 5B and the XML code 522 is for displaying the part 526 of the user interface shown in FIG. 5B. As shown in FIG. 5B, the XML code 520 includes: (i) name=“userID” which is the name of the UI item 524 (this is not displayed on the UI), (ii) type=“str” which indicates the data type (string) to be entered through the UI item 524, (iii) default=“emtrace2” which is the initial default value to be displayed in the UI item 524, and (iv) desc=“ID or Email” which is the description of the UI item 524 to be displayed. The XML code 522 includes (i) name=“numPhotos” which is the name of the UI item 526 (this is not displayed on the UI), (ii) type=“int” which indicates the data type (integer) to be entered through the UI item 526, (iii) default=“25” which is the initial default value to be displayed in the UI item 526, (iv) filter-“10;50” which indicates the minimum and maximum values that are to be displayed in the UI item 526 for selection and entry, and (v) desc=“Number of Photos” which is the description of the UI item 526 to be displayed. Other parts (other than parts 524, 526) of the UI shown in FIG. 5B that do not require customization for each electronic device 104 may be provided by the service provider 102 to add to the UI settings provided by the electronic device 104.

Referring to FIG. 5C, the XML code 530 is for displaying the part 532 of the user interface shown in FIG. 5C. As shown in FIG. 5C, the XML code 530 includes: (i) name=“channel” which is the name of the UI item 532 (this is not displayed on the UI), (ii) type=“enum” which indicates the data type (enumeration, for selection from a plurality of options) to be entered through the UI item 532, (iii) default=“Top Stories” which is the initial default value to be displayed in the UI item 532, (iv) desc=“Category of News” which is the description of the UI item 532 to be displayed, and (v)<enum value=“Top Stories”/>, <enum value=“Sports”/>, <enum value=“Entertainment”/>, <enum value=“Health”/>, <enum value=“Business”/>, <enum value=“Most Popular”/> which enumerate the 6 options (Top Stories, Sports, Entertainment, Health, Business, and Most Popular) from which the user may select from the UI item 532. Other parts (other than part 532) of the UI shown in FIG. 5C that do not require customization for each electronic device 114 may be provided by the service provider 102 to add to the UI settings provided by the electronic device 114.

FIG. 5D is an interaction diagram illustrating a method for configuring a group of the electronic devices remotely from the service provider server, according to another embodiment of the present invention. The method of FIG. 5D enables remote configuration of multiple electronic devices 104, 114 as a single management unit when the multiple electronic devices 104, 114 are configured to share a common RCDB 116 on the service provider server 102. The multiple electronic devices 104, 114 are designated as belonging to the same group on the service provider server 102. According to the method of FIG. 5D, when a change is made to the RCDB 116, then the LCDBs 118, 120 on both of the electronic devices 104, 114 are synchronized with the RCDB 116 with the same configuration data, thereby enabling group remote configuration of the electronic devices 104, 114. The method of FIG. 5D enables the service provider server 102 to receive customized user interfaces for configuring the electronic devices 104, 114 from the electronic devices 104, 114 themselves, so that the service provider server 102 does not have to store any of the user interface information.

More specifically, referring to FIG. 5D, the service provider server receives 502 the configuration UI (user interface) settings XML file from one of the multiple electronic devices 104, 114, and in the example of FIG. 5D, from the electronic device 104. As explained previously, the configuration UI settings XML file is stored in the electronic device 104 itself. The service provider server 102 generates the user interface as an HTML (hypertext markup language) file using the configuration UI settings XML file and causes the UI to be displayed 504 on the user computer 106 through the Internet 100. The user enters 506 device configuration information (including configuration information for applications running on the electronic devices 104, 114) to the user computer 106 and the entered configuration information is transmitted 506 to the service provider server 102. The service provider server 102 updates 508 its RCDB 116 with the entered configuration information, and increases a version number associated with the RCDB 116. Then, the service provider server 102 transmits 510 the configuration information to the electronic device 104, and also transmits 511 the configuration information to the electronic device 114. The electronic device 104 updates 512 its LCDB 118 with the received configuration information, and also synchronizes 512 the version number associated with the configuration information stored in the LCDB 118 to be same as the version number associated with the configuration information stored in the RCDB 116. The electronic device 114 also updates 513 its LCDB 120 with the received configuration information, and also synchronizes 513 the version number associated with the configuration information stored in the LCDB 120 to be same as the version number associated with the configuration information stored in the RCDB 116. As a result, both electronic devices 104, 114 become remotely configured as a group through the service provider server 102, using the user interface settings stored in and provided by one of the electronic devices 104, 114.

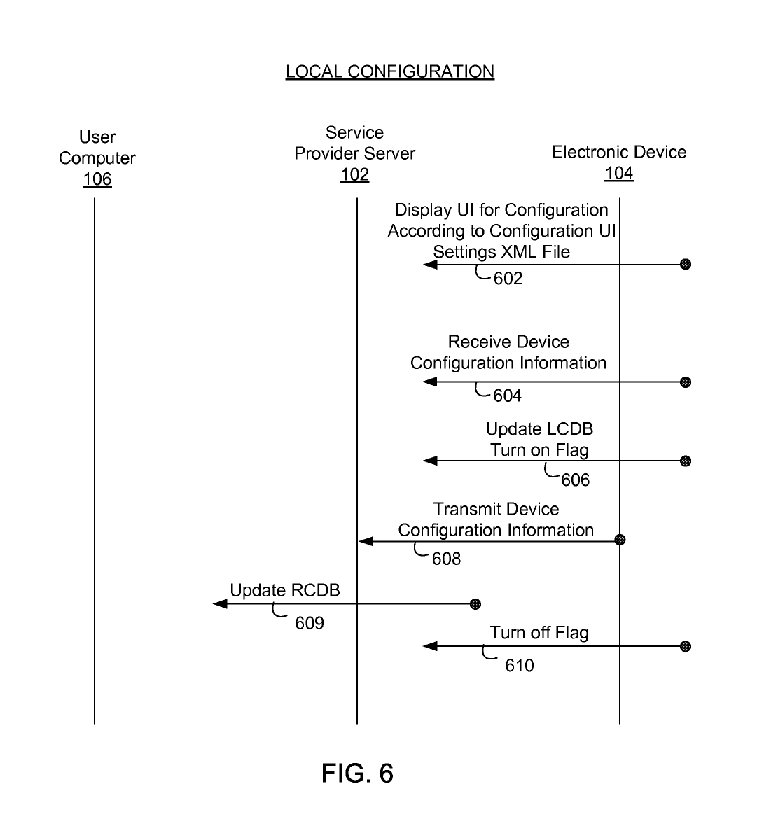

FIG. 6 is an interaction diagram illustrating a method for configuring the electronic device locally, according to one embodiment of the present invention. The electronic devices 104, 114 may also be configured locally. If the electronic devices 104, 114 are configured locally, the RCDB 116 in the service provider server 102 should also be updated at some point, so that the configuration data in the LCDBs 118, 120 in the electronic devices 104, 114 are synchronized with the configuration data in the RCDB 116 of the service provider server 102.

More specifically, referring to FIG. 6, the electronic device 104 displays 602 on its display 207 (FIG. 2A) the UI for configuration according to the configuration UI settings XML file stored in the electronic device 104 itself. The electronic device 104 receives 604 device configuration information (including configuration information for applications running on the electronic devices 104) entered to the electronic device 104 by the user via the input module 206 (FIG. 2A), and updates 606 its LCDB 118 with the entered configuration information, and also turns on 606 a flag indicating an change or update to the configuration information stored in the LCDB 118 (e.g., flag is changes from 0 to 1). The LCDB 118 also has an LCDB version number, but the LCDB 118 does not increase its version number on its own, but merely synchronizes with the version number of the RCDB 116 when there is a difference between the LCDB version number and the RCDB version number. Then, the electronic device 104 transmits 608 the configuration information to the service provider server 102. In response, the service provider server 102 updates 609 the RCDB 116 with the received device configuration information, and the electronic device 104 turns off 610 the flag of the LCDB 118 (e.g., flag is changes from 1 to 0).

FIG. 7 is a flowchart illustrating a method for synchronizing the configuration information between the service provider server and the electronic device, according to one embodiment of the present invention. The electronic devices 104, 114 maintain their LCDBs 118, 120 to be synchronized with the RCDB 116 of the service provider server 102, so that the LCDBs 118, 120 have the same configuration data as the configuration data stored in the RCDB 116.

More specifically, when the electronic device 104 becomes communicatively connected 702 to the service provider server 102 (for example, when the electronic device 104 becomes powered on or when the electronic device 104 receives a push message from the service provider server 102 indicating a change in the RCDB 116), the electronic device 104 compares 704 the version numbers of the RCDB 116 and the LCDB 118 and also checks 704 the flag of the LCDB 118. If the RCDB version number is greater than the LCDB version number and the flag of the LCDB 118 is off in step 706 (indicating a remote configuration of the RCDB 116), the configuration information stored in the RCDB 116 is downloaded 708 from the service provider server 102 to the LCDB 118 of the electronic device 104, and the LCDB version number is synchronized 710 to be same as the RCDB version number. If the RCDB version number is greater than the LCDB version number and the flag of the LCDB 118 is on in step 712, this indicates that both the RCDB 116 and the LCDB 118 have been modified. This situation could occur when the RCDB 116 is updated remotely and the LCDB 118 is also updated locally without the opportunity to synchronize the RCDB 116 and the LCDB 118 due to, for example, disconnection from the network. In this case 712, the RCDB is given priority for consistency. Thus, the configuration information stored in the RCDB 116 is downloaded 714 from the service provider server 102 to the LCDB 118 of the electronic device 104, the LCDB version number is synchronized 716 to be same as the RCDB version number, and the flag of the LCDB 118 is turned off 718. If the RCDB version number is equal to the LCDB version number and the flag of the LCDB 118 is off in step 720 (indicating no updates or changes to the RCDB 116 or LCDB 118), then nothing needs to be done 722. If the RCDB version number is equal to the LCDB version number and the flag of the LCDB 118 is on in step 724, this means that the LCDB 118 has been locally updated. Thus, the configuration information stored in the LCDB 118 is uploaded 726 from electronic device 104 to the RCDB 116 of the service provider server 102, and the flag of the LCDB is turned off 728.

Upon reading this disclosure, those of ordinary skill in the art will appreciate still additional alternative structural and functional designs for a system and a process for remote configuration of electronic devices through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer-implemented method of remotely configuring an electronic device, the method comprising:
a server receiving user interface information stored in the electronic device via a data communication network from the electronic device, the server communicatively coupled to the electronic device through a data communication network;
the server causing a user interface to be generated and displayed on a user computer based on the received the user interface information, the user computer communicatively coupled to the server through the data communication network;
the server receiving configuration information for configuring an application to be executed on the electronic device from the user computer; and
the server transmitting the received configuration information to the electronic device via the data communication network to remotely configure the application to be executed on the electronic device.

2. The method of claim 1, wherein the server comprises a remote configuration database for storing the configuration information, and the method further comprises:
the server updating the remote configuration database based on the received configuration information.

3. The method of claim 2, wherein the remote configuration database is associated with a remote configuration database version number that is increased in response to the server updating the remote configuration database.

4. The method of claim 3, wherein the electronic device comprises a local configuration database for storing the configuration information, and the method further comprises:
the electronic device updating the local configuration database based on the received configuration information transmitted from the server.

5. The method of claim 4, wherein the local configuration database is associated with a local configuration database version number that is synchronized with the remote configuration database version number.

6. The method of claim 5, wherein the local configuration database is updated based on the received configuration information transmitted from the server if the remote configuration database version number exceeds the local configuration database version number.

7. The method of claim 5, further comprising transmitting the configuration information from the electronic device to the server if a flag of the local configuration database indicates a change made to the local configuration database.

8. The method of claim 1, wherein the user interface information comprises an XML (eXtensible Markup Language) file representing the user interface to be displayed by the server on the user computer.

9. The method of claim 8, wherein the server generates the user interface as an HTML (Hypertext Markup Language) file for display on the user computer through the data communication network.

10. The method of claim 1, further comprising:
the server transmitting the same received configuration information to another electronic device via the data communication network to remotely configure the application to be executed on said another electronic device, both the electronic device and said another electronic device being configured remotely as a group by the server.

11. A computer program product stored on a computer readable medium and adapted to perform a computer-implemented method of remotely configuring an electronic device, the method comprising:
a server receiving user interface information stored in the electronic device via a data communication network from the electronic device, the server communicatively coupled to the electronic device through a data communication network;
the server causing a user interface to be generated and displayed on a user computer based on the received the user interface information, the user computer communicatively coupled to the server through the data communication network;
the server receiving configuration information for configuring an application to be executed on the electronic device from the user computer; and
the server transmitting the received configuration information to the electronic device via the data communication network to remotely configure the application to be executed on the electronic device.

12. The computer program product of claim 11, wherein the server comprises a remote configuration database for storing the configuration information, and the method further comprises:
the server updating the remote configuration database based on the received configuration information.

13. The computer program product of claim 12, wherein the remote configuration database is associated with a remote configuration database version number that is increased in response to the server updating the remote configuration database.

14. The computer program product of claim 13, wherein the electronic device comprises a local configuration database for storing the configuration information, and the method further comprises:
the electronic device updating the local configuration database based on the received configuration information transmitted from the server.

15. The computer program product of claim 14, wherein the local configuration database is associated with a local configuration database version number that is synchronized with the remote configuration database version number.

16. The computer program product of claim 15, wherein the local configuration database is updated based on the received configuration information transmitted from the server if the remote configuration database version number exceeds the local configuration database version number.

17. The computer program product of claim 15, wherein the method further comprises transmitting the configuration information from the electronic device to the server if a flag of the local configuration database indicates a change made to the local configuration database.

18. The computer program product of claim 11, wherein the user interface information comprises an XML (eXtensible Markup Language) file representing the user interface to be displayed by the server on the user computer.

19. The computer program product of claim 18, wherein the server generates the user interface as an HTML (Hypertext Markup Language) file for display on the user computer through the data communication network.

20. The computer program product of claim 11, wherein the method further comprises:
the server transmitting the same received configuration information to another electronic device via the data communication network to remotely configure the application to be executed on said another electronic device, both the electronic device and said another electronic device being configured remotely as a group by the server.
